(19) United States
(12) Patent Application Publication
(10) Pub. No.: US 2025/0067091 A1
(43) Pub. Date: Feb. 27, 2025

(54) ACTUATOR FOR VEHICLE LATCH

(71) Applicant: INTEVA PRODUCTS, LLC, Troy, MI (US)

(72) Inventors: Donald Michael Perkins, Rochester Hills, MI (US); Tania Soto, Chihuahua (MX)

(21) Appl. No.: 18/812,468

(22) Filed: Aug. 22, 2024

Related U.S. Application Data
(60) Provisional application No. 63/534,830, filed on Aug. 26, 2023.
(60) Provisional application No. 63/534,044, filed on Aug. 22, 2023.

(51) Int. Cl. E05B 77/34; E05B 79/20; E05B 83/24; F16H 37/12; F16H 57/02; F16H 57/029

(52) U.S. Cl. CPC E05B 77/34; E05B 83/24; F16H 37/124; F16H 57/029; E05B 79/20; F16H 2057/02082

(57) ABSTRACT

An actuator for a vehicle latch, including: an actuator housing; an actuator cover; a dual function lever rotatably secured to the actuator; a service release lever rotatably secured to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and a service release cable secured to the service release lever wherein the service release cable may be secured to opposite sides of the actuator while still being secured to the service release lever.

### CROSS REFERENCE TO RELATED APPLICATIONS

This application claims priority to U.S. Provisional Patent Application No. 63/534,044 filed on Aug. 22, 2023 and U.S. Provisional Patent Application No. 63/534,830 filed on Aug. 26, 2023, the contents each of which are incorporated herein.

### BACKGROUND

Exemplary embodiments of the present disclosure pertain to the art of vehicle latches and in particular an actuator for a vehicle latch.

### BRIEF DESCRIPTION

Disclosed is an actuator for a vehicle latch, including: an actuator housing; an actuator cover; a dual function lever rotatably secured to the actuator; a service release lever rotatably secured to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and a service release cable secured to the service release lever wherein the service release cable may be secured to opposite sides of the actuator while still being secured to the service release lever.

In addition to one or more of the features described above, or as an alternative to any of the foregoing embodiments, a seal is located between the actuator housing and the actuator cover when the actuator housing and the actuator cover are secured together.

In addition to one or more of the features described above, or as an alternative to any of the foregoing embodiments, the seal is formed from an elastomeric material or rubber.

In addition to one or more of the features described above, or as an alternative to any of the foregoing embodiments, the seal has a first portion that performs a perimeter seal function between the actuator housing and the actuator cover when the actuator housing and the actuator cover are secured together and a second portion that performs a sealing function between the dual function lever and the gear when the actuator housing and the actuator cover are secured together.

In addition to one or more of the features described above, or as an alternative to any of the foregoing embodiments, the first portion and the second portion are integrally formed together such that the seal is a single unitary structure.

In addition to one or more of the features described above, or as an alternative to any of the foregoing embodiments, the seal is molded into the actuator cover.

In addition to one or more of the features described above, or as an alternative to any of the foregoing embodiments, the second portion of the seal interacts with the gear to seal an interface between the gear and the dual function lever.

In addition to one or more of the features described above, or as an alternative to any of the foregoing embodiments, the dual function lever is secured to a pivot of the gear.

In addition to one or more of the features described above, or as an alternative to any of the foregoing embodiments, the second portion of the seal interacts with the pivot to seal an interface between the gear and the dual function lever.

In addition to one or more of the features described above, or as an alternative to any of the foregoing embodiments, the second portion of the seal has two sealing features interacting with two different diameters of the pivot of the gear.

In addition to one or more of the features described above, or as an alternative to any of the foregoing embodiments, the second portion of the seal has a first sealing feature and a second sealing feature each contacting the pivot of the gear.

In addition to one or more of the features described above, or as an alternative to any of the foregoing embodiments, a gap between the first sealing feature and the second sealing feature is filled with grease.

In addition to one or more of the features described above, or as an alternative to any of the foregoing embodiments, the first portion of the seal provides a seal interface between the actuator cover and the actuator housing when the actuator housing and the actuator cover are secured together.

In addition to one or more of the features described above, or as an alternative to any of the foregoing embodiments, the seal interacts with actuator housing with at least two sealing features that compress the seal.

In addition to one or more of the features described above, or as an alternative to any of the foregoing embodiments, a perimeter of the actuator housing has a recess that receives a complementary protrusion of the first portion of the seal and the perimeter of the actuator housing has a protrusion that is received in a complementary recess of the first portion of the seal.

In addition to one or more of the features described above, or as an alternative to any of the foregoing embodiments, the recess of the actuator housing is located closer to an exterior perimeter of the actuator housing than the complementary recess of the first portion of the seal.

Also disclosed is an actuator for a vehicle latch, including: an actuator housing; an actuator cover; a dual function lever rotatably secured to the actuator; a service release lever rotatably secured to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and a seal located between the actuator housing and the actuator cover, the seal having a first portion that performs a perimeter seal function between the actuator housing and the actuator cover when they are secured together and a second portion that performs a sealing function between the dual function lever and the gear when the actuator housing and the actuator cover are secured together.

In addition to one or more of the features described above, or as an alternative to any of the foregoing embodiments, the first portion and the second portion are integrally formed together such that the seal is a single unitary structure and the seal is molded into the actuator cover.

In addition to one or more of the features described above, or as an alternative to any of the foregoing embodiments, a service release cable is secured to the service release lever wherein the service release cable may be secured to opposite sides of the actuator while still being secured to the service release lever.

Also disclosed is a method of sealing an actuator housing of an actuator to an actuator cover of the actuator, including: rotatably securing a dual function lever to the actuator; rotatably securing a service release lever to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and locating a seal between the actuator housing and the actuator cover, the seal having a first portion that performs a perimeter seal function between the actuator housing and the actuator cover when they are secured together and a second portion that performs a sealing function between the dual function lever and the gear when the actuator housing and the actuator cover are secured together.

### BRIEF DESCRIPTION OF THE DRAWINGS

The following descriptions should not be considered limiting in any way. With reference to the accompanying drawings, like elements are numbered alike:

FIG. 1 is a perspective view of an actuator for a vehicle latch;

FIG. 2 is a front view of the actuator of FIG. 1;

FIG. 3 is a rear view of the actuator of FIG. 1;

FIG. 4 is a top view of the actuator of FIG. 1;

FIG. 5 is a bottom view of the actuator of FIG. 1;

FIG. 6 is a right side view of the actuator of FIG. 1;

FIG. 7 is a left side view of the actuator of FIG. 1;

FIGS. 8 and 9 illustrate a gear train of the actuator of FIG. 1;

FIGS. 10A and 10B illustrate movement of the actuator of FIG. 1 in a first direction;

FIGS. 11A and 11B illustrate movement of the actuator of FIG. 1 in a second direction;

FIG. 12 illustrates the actuator cover with a molded seal in accordance with the present disclosure;

FIG. 13 is a view along lines 13-13 of FIG. 12;

FIGS. 14 and 15 are enlarged portions of FIG. 13;

FIG. 16 illustrates the actuator cover with a molded seal in accordance with the present disclosure;

FIG. 17 is a view along lines 17-17 of FIG. 16;

FIG. 18 is an enlarged portion of FIG. 17;

FIG. 19 illustrates the actuator cover with a molded seal in accordance with the present disclosure;

FIG. 20 is a cross-sectional view of the actuator cover illustrated in FIG. 19;

FIG. 21 is an enlarged portion of FIG. 21;

FIG. 22 is an enlarged portion of FIG. 21; and

FIG. 23 is an enlarged portion of FIG. 22.

### DETAILED DESCRIPTION

A detailed description of one or more embodiments of the disclosed apparatus and method are presented herein by way of exemplification and not limitation with reference to the Figures.

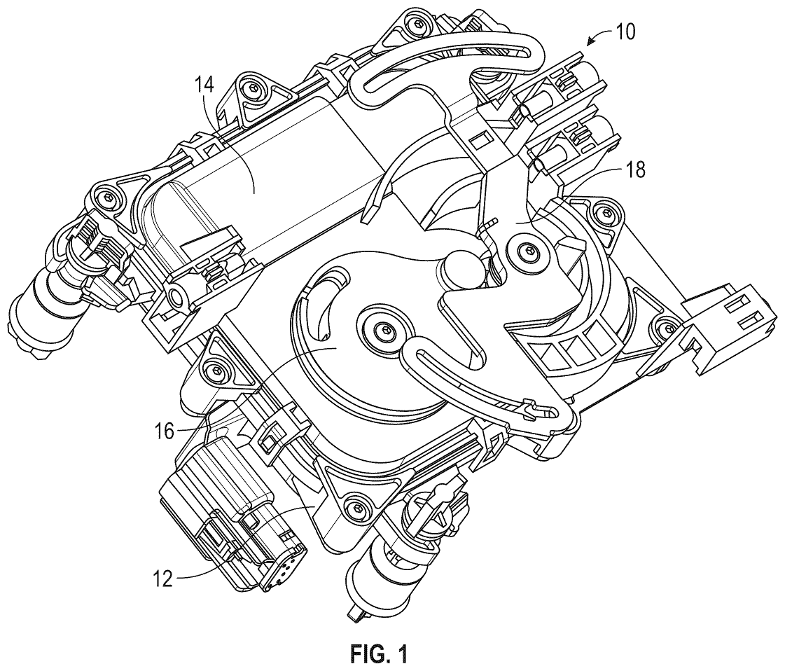

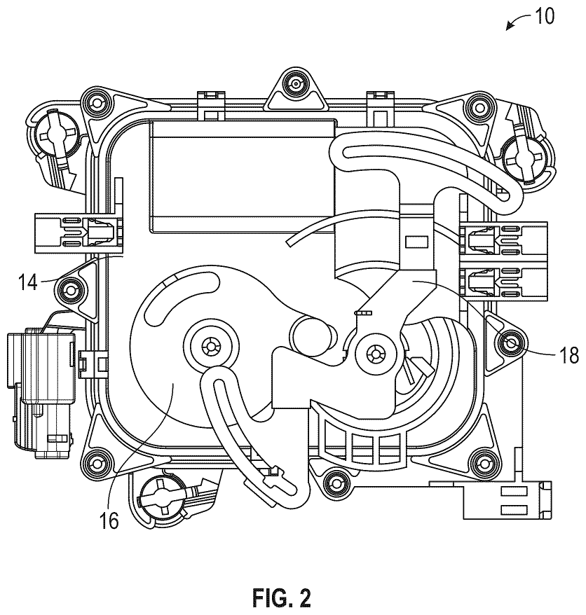

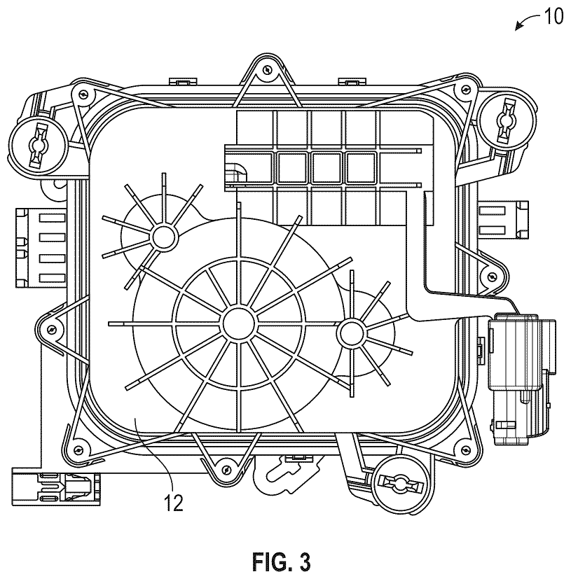

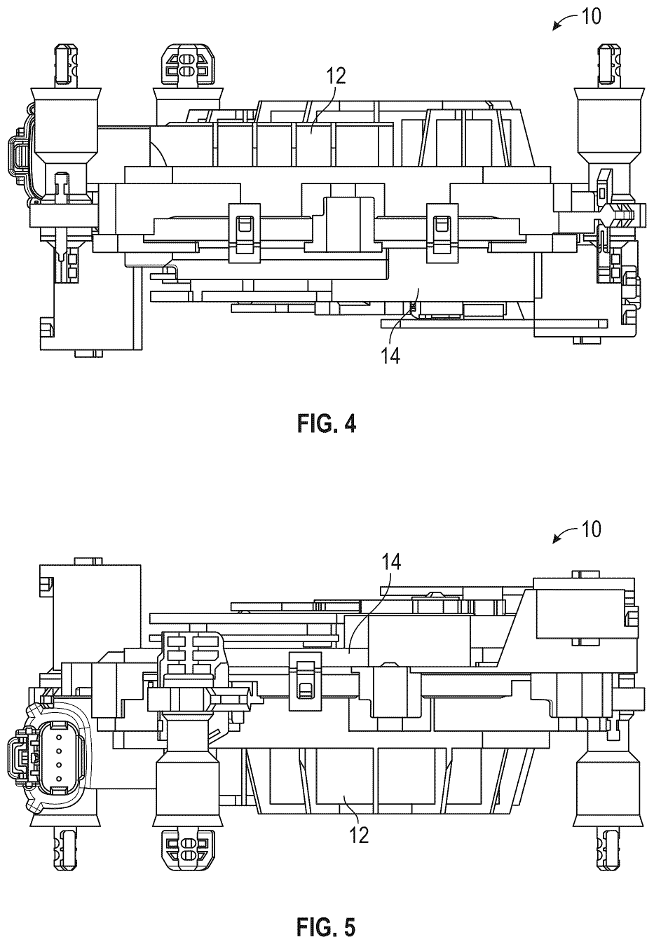

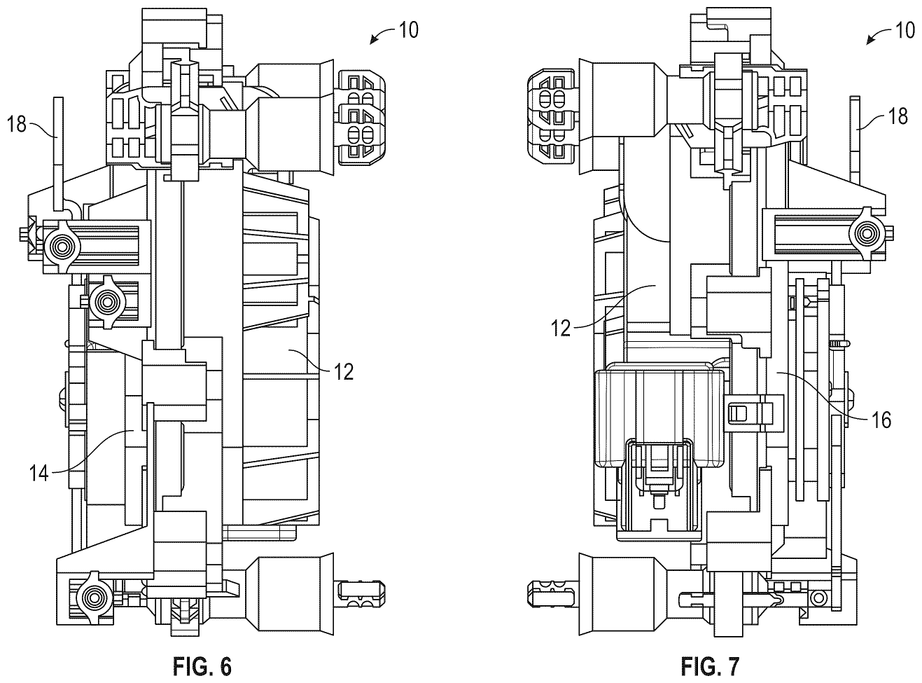

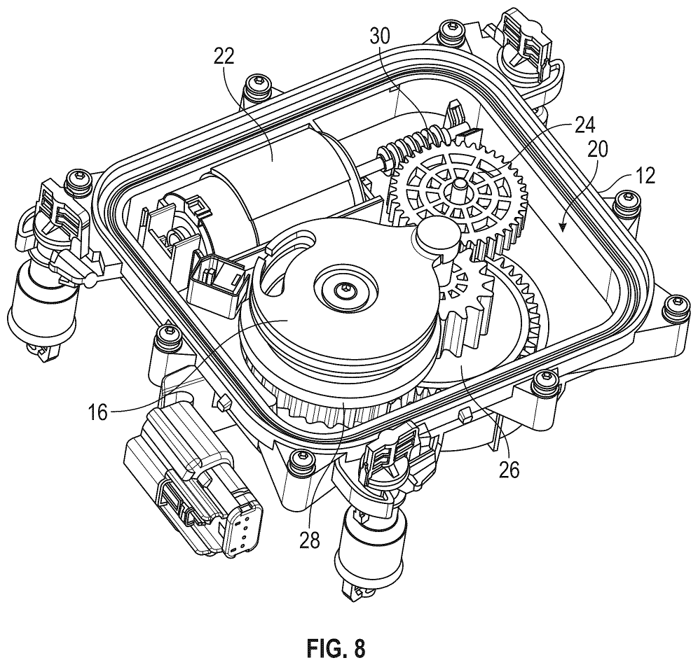

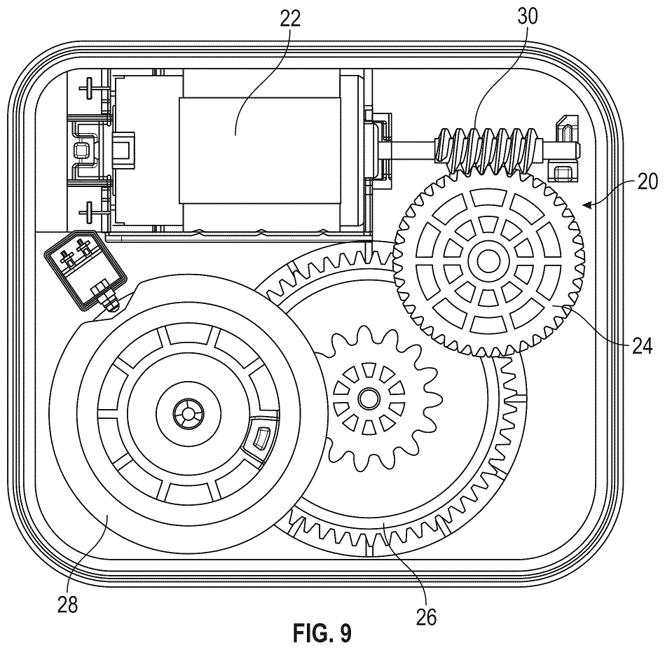

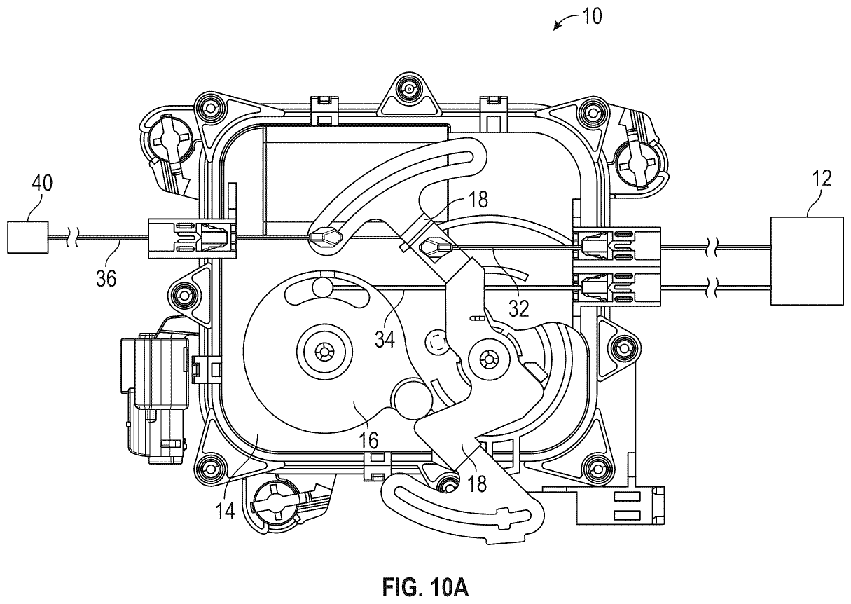

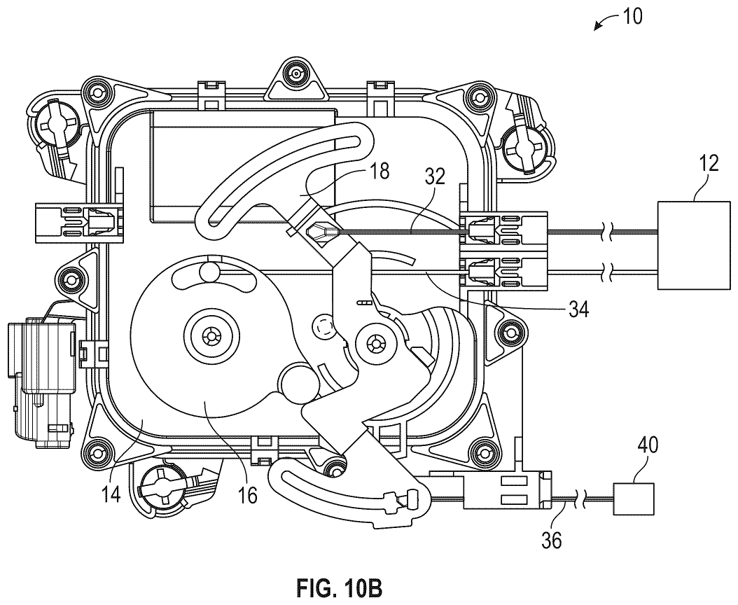

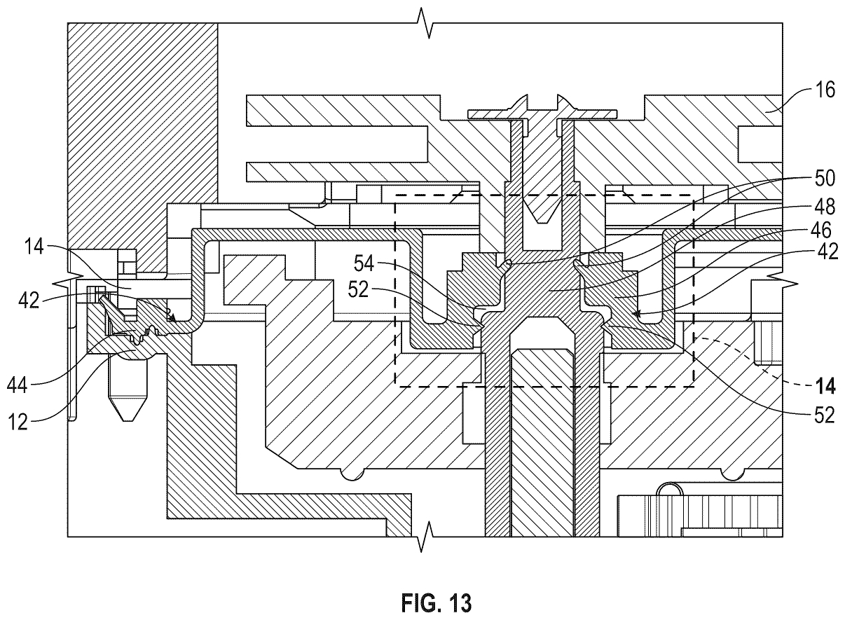

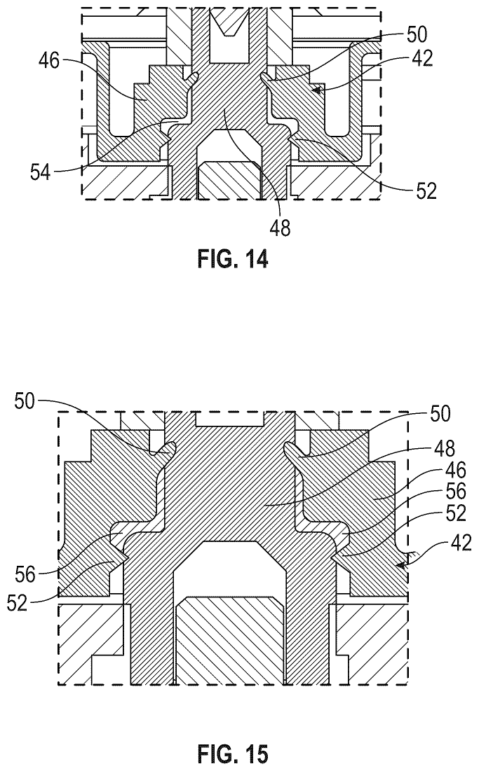

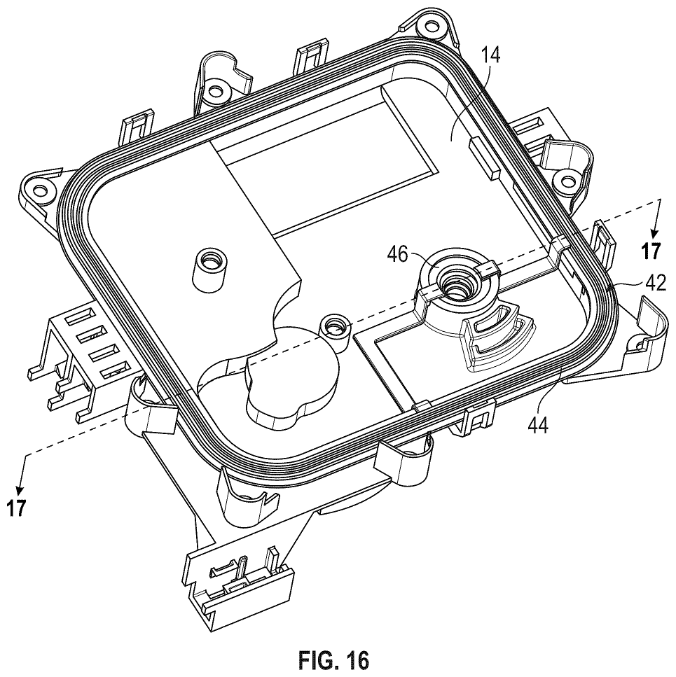

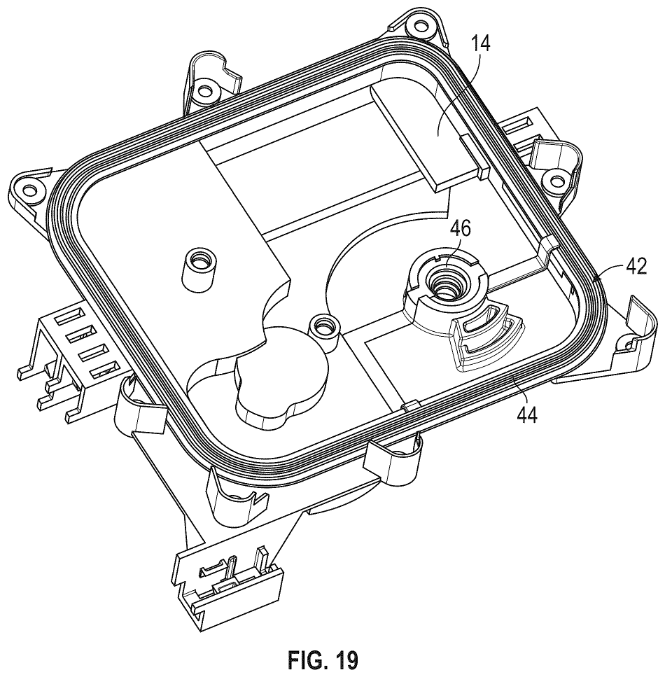

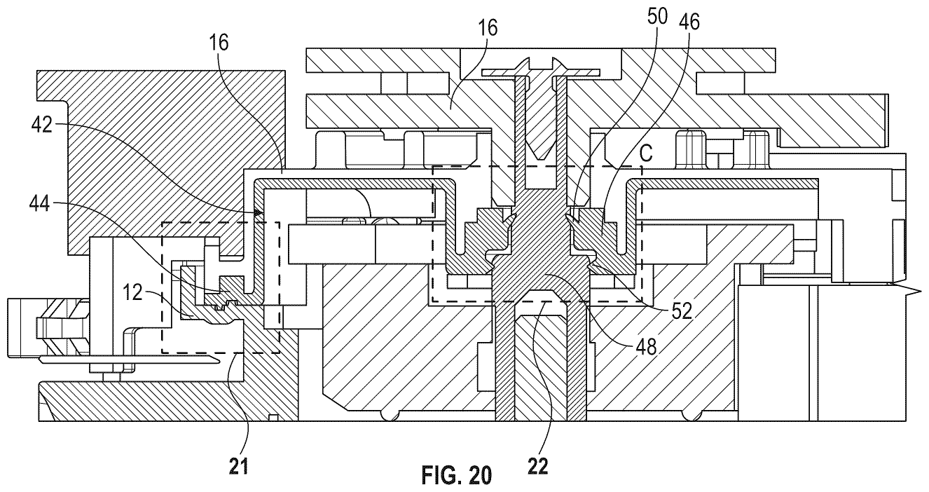

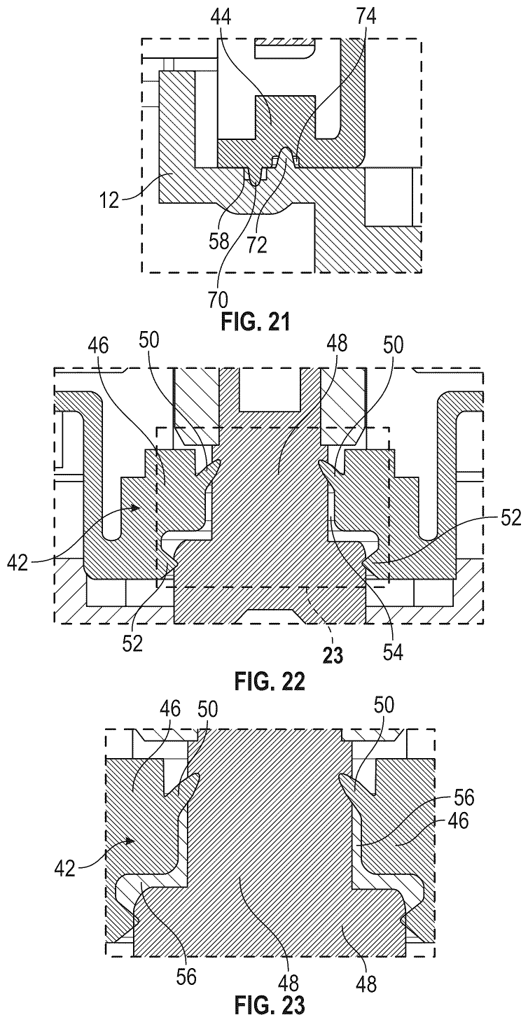

Referring now to FIGS. 1-23, an actuator 10 for a vehicle latch is illustrated. In one non-limiting embodiment, the actuator 10 may be remotely coupled to a vehicle hood latch 12 (illustrated schematically in at least FIG. 10B).

The actuator 10 has an actuator housing 12 and an actuator cover 14. A dual function lever 16 and a service release lever 18 are rotatably secured to the actuator 10. In addition, the dual function lever 16 and the service release lever 18 are located outside of the actuator so that they can rotate about and with respect to an exterior of the actuator 10. The dual function lever 16 is rotatably driven by a gear train 20 operably coupled to the dual function lever 16 at one end and a motor 22 at another end. The gear train 20 may be a three stage gear train 20 comprising a first gear 24, a second gear 26 and a third gear 28. The three stage gear train 20 is located inside the actuator housing 12 and actuator cover 14 and the third gear 28 is coupled with the dual function lever 16 located outside of the actuator 10. The first gear 24 meshingly engages a worm 30 driven by the motor 22. The first gear 24 meshingly engages the second gear 26 and the second gear 26 also meshingly engages the third gear 28. The third gear 28 is operably coupled to the dual function lever 16 such that rotation of the third gear 28 rotates the dual function lever 16.

The motor 22, the gear train 20 and the dual function lever 16 are all capable of being driven in two different directions (e.g., a first direction and a second direction). The first direction being opposite to the second direction. It being understood that while a gear train having three gears is illustrated various embodiments of the present disclosure contemplate gear trains 20 that may have more or less than three gears.

In accordance with the present disclosure and in order to prevent water and dust from entering the interior of the actuator 10 all cables are mounted outside of the actuator 10 in order to prevent the possibility of water from getting inside the actuator 10. In other words and in one non-limiting embodiment, none of the cables pass through into an interior of the actuator 10 defined by the actuator housing 12 and actuator cover 14 when they are secured to each other. Therefore and in order to completely seal the actuator 10, a perimeter and shaft seal are provided for the actuator 10.

A latch release cable 32 is secured to the service release lever 18 at one end and the vehicle hood latch 12 at another end such that movement of the service release lever 18 by the dual function lever 16 will cause a desired operation of the vehicle hood latch 12.

A cinch release cable 34 is secured to the dual function lever 16 at one end and the vehicle hood latch 12 at another end such that movement of the dual function lever 16 will cause a desired operation of the vehicle hood latch 12. For example, the cinch release cable 34 may be connected to a cinch mechanism of the latch 12.

FIGS. 10A and 10B illustrate movement of the dual function lever 16 and the service release lever 18 in one operation. FIG. 10A illustrates the actuator 10 and the dual function lever 16 at an initial position. In FIG. 10B the dual function lever 16 is rotated clockwise with respect to the view illustrated in FIGS. 10A and 10B. The dual function lever 16 is operably coupled to the service release lever 18, as such, rotation of the dual function lever 16 clockwise will cause a counter clockwise (with respect to the view illustrated in FIGS. 10A and 10B) movement of the service release lever, which in turn will cause movement of the latch release cable 32 (e.g., pull the latch release cable 32) thereby causing a desired operation of the vehicle hood latch 12. In other words and as illustrated, the dual function lever 16 is configured to contact and push the service release lever 18 in one operation.

A service release cable 36 is also secured to the service release lever 18 at one end and a mechanical release actuator 40 (illustrated schematically in at least FIG. 10B).

In accordance with the present disclosure, the service release cable 36 may be secured to opposite sides of the actuator 10. This is due to in at least in part the configuration of the service release lever 18. In FIG. 10A, the service release cable 36 is secured to the service release lever 18 such that it extends from the left side of the actuator (with respect to the view illustrated in FIG. 10A).

Alternatively and referring now to FIG. 10B and in accordance with the present disclosure, the service release cable 36 is secured to the service release lever 18 such that it extends from the right side of the actuator (with respect to the view illustrated in FIG. 10B). As such, the service release lever 18 can be operated in two directions by assembling the service release cable 36 in opposite directions to simplify cable layout on a vehicle.

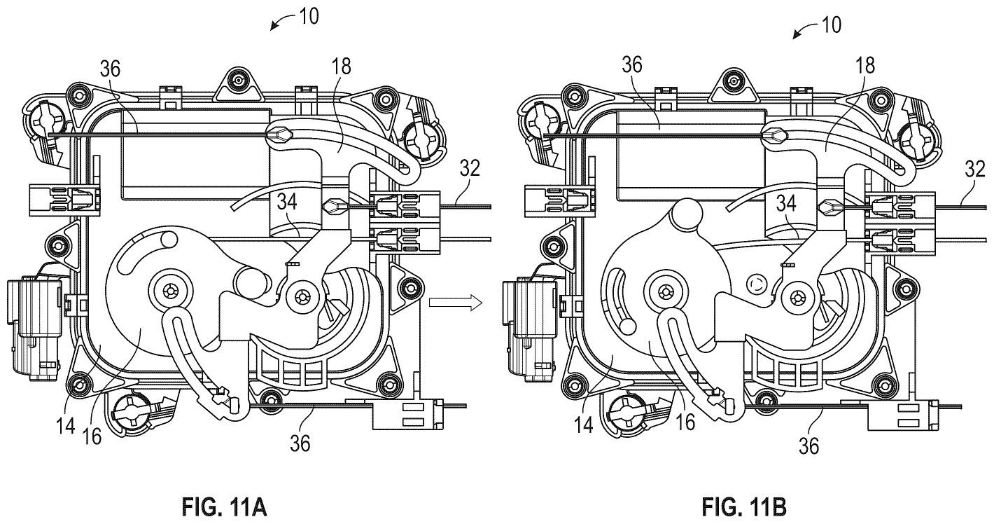

Referring now to FIGS. 11A and 11B movement of the dual function lever 16 of the actuator 10 in a second direction (opposite to that illustrated in FIGS. 10A and 10B) is illustrated. Since the dual function lever 16 is secured to the cinch release cable 34, movement of the dual function lever 16 in a counter clockwise movement with respect to the view illustrated in FIGS. 11A and 11B will cause a desired operation of the vehicle hood latch 12 as the cinch release cable 34 is pulled by the dual function lever 16. As such and as illustrated in at least FIGS. 11A and 11B, the dual function lever 16 is rotated counter clockwise from an initial position illustrated in at least FIG. 11A to a second position illustrated in at least FIG. 11B where the cinch release cable is pulled by the dual function lever 16.

Note: FIGS. 11A and 11B illustrate the service release cable 36 secured to the service release lever 18 at two locations (e.g., left and right) however and in at least one embodiment the service release cable 36 is only secured to the service release lever 18 as one location (e.g., left or right). Although and if applicable (e.g., due to the vehicle configuration) it may be possible in an alternative embodiment to have two service release cables 36 secured to the service release lever 18 although various embodiments of the present disclosure contemplate embodiments where the service release cable 36 is only secured to the service release lever 18 as one location (e.g., left or right).

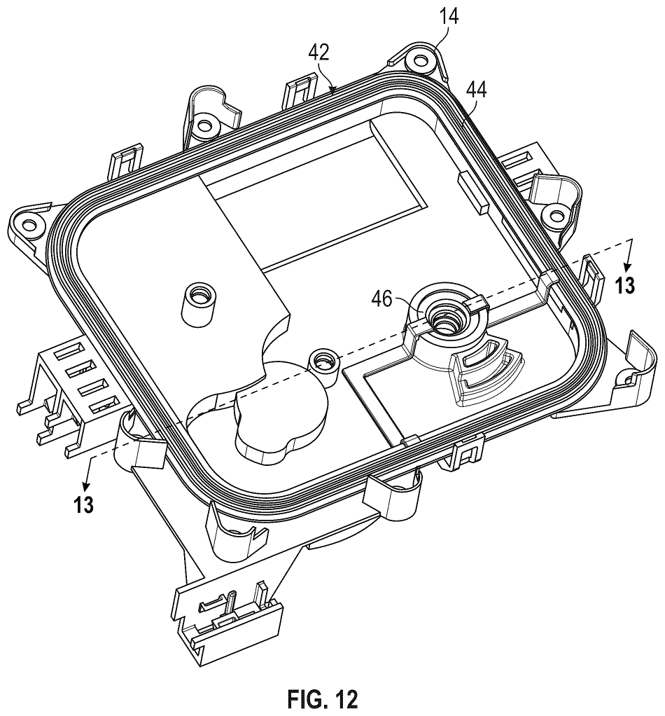

Referring now to at least FIGS. 12-23, the actuator cover 14 of the present disclosure is illustrated. In accordance with the present disclosure, the actuator cover 14 has a molded seal 42. In one non-limiting embodiment, the molded seal is formed from an elastomeric material or rubber. In accordance with the present disclosure, the molded seal 42 provides a waterproof housing wherein moisture and dirt and debris is prevented from entering the interior of the actuator. As such, a waterproof housing 12 and actuator cover 14 protecting the motor 22 the gear train 20 ensures their operation under extreme environmental exposures.

In accordance with the present disclosure, the molded seal 42 has two portions. A first portion 44 that performs a perimeter seal function between the actuator housing 12 and the actuator cover 14 and a second portion 46 that performs a sealing function between the dual function lever 16 and the gear train 20 in particular, the third gear 28 of the gear train 20. The first portion 44 is located about the entire periphery of the actuator cover 14 and performs a sealing function between the actuator cover 14 and the actuator housing 12 when the actuator cover 14 and the actuator housing 12 are secured to each other.

In one embodiment, the first portion 44 and the second portion 46 are integrally formed together such that the molded seal 42 is a single unitary structure when it is molded into the actuator cover 14. In other words, the second portion 46 extends from the first portion 44. In one non-limiting embodiment, the second portion 46 extends from the first portion 44 at one location and is connected to the first portion 44 at another location. Alternatively, the molded seal 42 may comprise two separate portions (e.g., the first portion 44 and the second portion 46) that are separately molded into the actuator cover 14. In yet another alternative, the molded seal 42 whether a single structure or multiple portions may be insert molded into the actuator cover 14 or manually installed into the actuator cover. Still further and in any of the above alternatives, the seal 42 may be secured to the actuator housing 12 as opposed to the actuator cover 14.

The dual function lever 16 is secured to a pivot 48 of the third gear 24 such that rotation of the third gear 24 will cause rotation of the dual function lever 16 as mentioned above.

At least a portion of the second portion 46 of the elastomeric seal 42 interacts with the third gear 24 of the gear train 20 to seal the interface between the internal gear train 20 and the external dual function lever 16 when the actuator cover 14 is secured to the actuator housing 12. In accordance with one non-limiting embodiment of the present disclosure, the second portion 46 of the elastomeric seal 42 has two sealing features (e.g., a first sealing feature 50 and a second sealing feature 52) interacting with two different diameters of the pivot 48 of the third gear 24. Thus, two points of contact or seals are made by the second portion 46 of the elastomeric seal 42.

In one non-limiting embodiment, a 54 gap between the first sealing feature 50 and the second sealing feature 52 of the second portion 46 of the elastomeric seal 42 is filled with grease 56. As such, the gap 54 between the sealing features 50 and 52 is filled up with grease 56 to provide lubrication during gear rotation and provide a secondary sealing if the elastomeric or rubber seal 42 is worn.

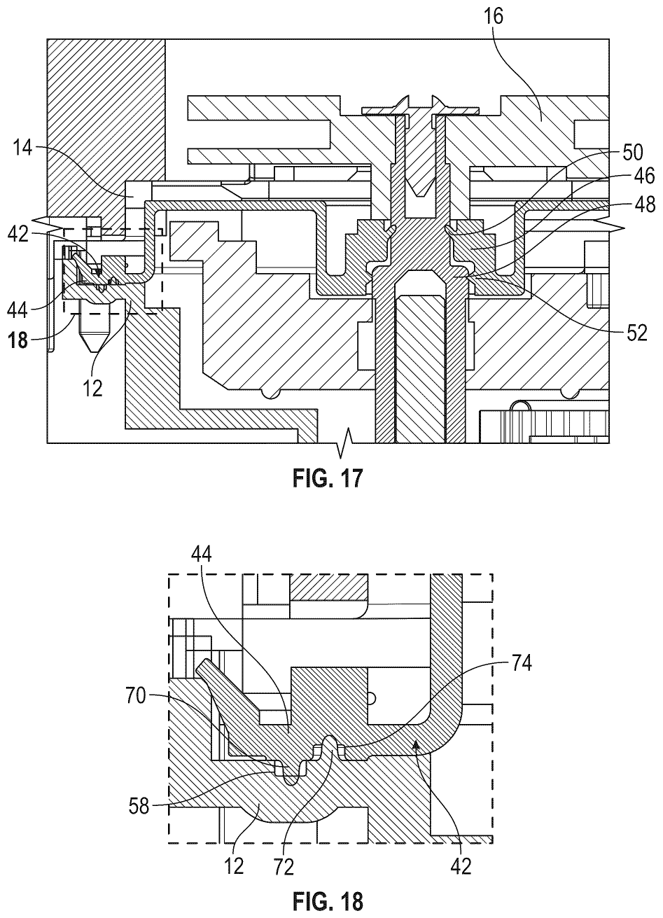

The first portion 44 of the elastomeric seal 42 provides a seal interface between the actuator cover 14 and the actuator housing 12 when they are secured to each other. As illustrated in at least FIGS. 17 and 18, the actuator housing 12 and actuator cover 14 interface is sealed by the elastomeric 42 seal that is molded into the actuator cover 14 and interacts with actuator housing 12 perimeter with at least two sealing features that compress the seal. In one embodiment, the perimeter of the actuator housing 12 has a recess 58 that receives a complementary protrusion 70 of the first portion 44 of the elastomeric seal 42 and the perimeter of the actuator housing 12 has a protrusion 72 that is received in a complementary recess 74 of the first portion 44 of the elastomeric seal 42. In one non-limiting embodiment, the recess 58 and the complementary protrusion 70 are located closer to the exterior perimeter of the actuator housing 12 and the protrusion 72 and the complementary recess 74 are located further from the exterior perimeter of the actuator housing 12. In an alternative embodiment, these locations may be reversed such that the protrusion 72 and the complementary recess 74 are located closer to the exterior perimeter of the actuator housing 12 than recess 58 and the complementary protrusion 70. In addition and as mentioned above, these features where applicable may also be located in the actuator cover 14 as opposed to the actuator housing 12.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An actuator for a vehicle latch, comprising:
an actuator housing;
an actuator cover;
a dual function lever rotatably secured to the actuator;
a service release lever rotatably secured to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and
a service release cable secured to the service release lever wherein the service release cable may be secured to opposite sides of the actuator while still being secured to the service release lever.

2. The actuator as in claim 1, wherein further comprising a seal located between the actuator housing and the actuator cover when the actuator housing and the actuator cover are secured together.

3. The actuator as in claim 2, wherein the seal is formed from an elastomeric material or rubber.

4. The actuator as in claim 2, wherein the seal has a first portion that performs a perimeter seal function between the actuator housing and the actuator cover when the actuator housing and the actuator cover are secured together and a second portion that performs a sealing function between the dual function lever and the gear when the actuator housing and the actuator cover are secured together.

5. The actuator as in claim 4, wherein the first portion and the second portion are integrally formed together such that the seal is a single unitary structure.

6. The actuator as in claim 5, wherein the seal is molded into the actuator cover.

7. The actuator as in claim 5, wherein the second portion of the seal interacts with the gear to seal an interface between the gear and the dual function lever.

8. The actuator as in claim 5, wherein the dual function lever is secured to a pivot of the gear.

9. The actuator as in claim 8, wherein the second portion of the seal interacts with the pivot to seal an interface between the gear and the dual function lever.

10. The actuator as in claim 9, wherein the second portion of the seal has two sealing features interacting with two different diameters of the pivot of the gear.

11. The actuator as in claim 9, wherein the second portion of the seal has a first sealing feature and a second sealing feature each contacting the pivot of the gear.

12. The actuator as in claim 11, wherein a gap between the first sealing feature and the second sealing feature is filled with grease.

13. The actuator as in claim 5, wherein the first portion of the seal provides a seal interface between the actuator cover and the actuator housing when the actuator housing and the actuator cover are secured together.

14. The actuator as in claim 13, wherein the seal interacts with actuator housing with at least two sealing features that compress the seal.

15. The actuator as in claim 13, wherein a perimeter of the actuator housing has a recess that receives a complementary protrusion of the first portion of the seal and the perimeter of the actuator housing has a protrusion that is received in a complementary recess of the first portion of the seal.

16. The actuator as in claim 15, wherein the recess of the actuator housing is located closer to an exterior perimeter of the actuator housing than the complementary recess of the first portion of the seal.

17. An actuator for a vehicle latch, comprising:
an actuator housing;
an actuator cover;
a dual function lever rotatably secured to the actuator;
a service release lever rotatably secured to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and
a seal located between the actuator housing and the actuator cover, the seal having a first portion that performs a perimeter seal function between the actuator housing and the actuator cover when they are secured together and a second portion that performs a sealing function between the dual function lever and the gear when the actuator housing and the actuator cover are secured together.

18. The actuator as in claim 17, wherein the first portion and the second portion are integrally formed together such that the seal is a single unitary structure and the seal is molded into the actuator cover.

19. The actuator as in claim 17, further comprising a service release cable secured to the service release lever wherein the service release cable may be secured to opposite sides of the actuator while still being secured to the service release lever.

20. A method of sealing an actuator housing of an actuator to an actuator cover of the actuator, comprising:
rotatably securing a dual function lever to the actuator;
rotatably securing a service release lever to the actuator, the dual function lever and the service release lever are located outside of the actuator so that they can rotate about an exterior of the actuator, the dual function lever being rotated by a gear located within the actuator housing and the actuator cover, wherein the dual function lever, the service release lever and the gear are all capable of being driven in a first direction and a second direction; and
locating a seal between the actuator housing and the actuator cover, the seal having a first portion that performs a perimeter seal function between the actuator housing and the actuator cover when they are secured together and a second portion that performs a sealing function between the dual function lever and the gear when the actuator housing and the actuator cover are secured together.
